(19) United States
(12) Patent Application Publication
(10) Pub. No.: US 2022/0275199 A1
(43) Pub. Date: Sep. 1, 2022

(54) POLYESTER RESIN COMPOSITION AND MOLDED PRODUCT THEREOF

(71) Applicant: Toray Industries, Inc., Tokyo (JP)

(72) Inventors: Xianwen Tang, Shanghai (CN); Junrui Xu, Shanghai (CN); Lezhen Zhang, Shanghai (CN); Koya Kato, Shanghai (CN); Kenji Ota, Nagoya (JP); Akitoshi Omayu, Suzhou (CN); Wenbo Zhu, Suzhou (CN)

(21) Appl. No.: 17/627,215

(22) PCT Filed: Jul. 20, 2020
(86) PCT No.: PCT/CN2020/102916

§ 371 Date: Jan. 14, 2022

(30) Foreign Application Priority Data
Jul. 22, 2019 (CN) 201910660370.0

(51) Int. Cl. C08L 67/02

(52) U.S. Cl. CPC C08L 67/02; C08L 2205/03; C08L 2205/025

(57) ABSTRACT

A polyester resin composition is obtained by compounding at least: (A) 100 parts by mass of a polybutylene terephthalate resin, (B) 15 to 100 parts by mass of an amorphous resin and (C) 0.01 to 5 parts by mass of an epoxy resin with a special structure, and the melting point of the polyester resin composition is greater than 210° C. but less than 221° C. The polyester resin composition and the molded product thereof have excellent laser transmittance and can be used for various electrical mounting components for automobiles, connectors, switch components, relay components.

### TECHNICAL FIELD

This disclosure relates to the field of polymer materials and, in particular, a polyester resin composition and a molded product thereof.

### BACKGROUND

Polybutylene terephthalate (PBT) resin has been widely applied to mechanical components, electrical communication components, automotive components and other fields due to its various excellent properties such as heat resistance, chemical resistance, electrical properties, mechanical properties and molding processability. Especially in recent years, its application to various automotive electrical mounting components has attracted extensive attention. However, the airtightness of these components must occasionally be ensured. Traditional coupling methods such as screw fastening, adhesive bonding, heating-plate deposition and ultrasonic deposition pose issues such as long process time and insufficient design freedom.

Laser welding, as an external heating welding technology, is an engineering method of melting and fusing by irradiating a laser beam on a laminated resin molded body and making the laser beam pass through the irradiated surface and be absorbed by the other surface. That method attracted extensive attention since it can meet the requirements for three-dimensional connection, non-contact processing and the absence of welding spatters. It also has the characteristics of rapid process, high design freedom and high bonding strength. Meanwhile, it can be seen from the above laser welding process that the laser transmittance of a welded material is one of the important parameters. When a PBT resin is bonded by laser welding, heat absorption deficiency would be easily caused if the laser transmittance of the resin is too low such that the welding and bonding cannot be completed finally. However, if the laser intensity is increased to compensate for the insufficient transmittance and improve the heat absorption of the welded surface, the material may be easily ablated and carbonized due to overheating. Therefore, it has been an ongoing concern in the field that how to effectively increase the laser transmittance of the welded material.

Among the existing technologies for improving the transmittance of resin materials for laser welding, Japanese Laid-Open Pub. No. 2010-70626 discloses a polyester resin composition that shows excellent laser transmittance as well as excellent cold and heat resistance and mechanical strength and is very effective for the laser welding of resin products. Its specific solution is as follows: a polyester resin composition, comprising (A) 29-84% by weight of polybutylene terephthalate (PBT) resin, (B) 5-60% by weight of at least one resin selected from a polyester resin in which repeating units formed by terephthalate groups and 1,4-cyclohexane dimethanol groups account for more than 25 mol %, and a polycarbonate resin, (C) 10-50% by weight of reinforcing fibers, (D) 1-20% by weight of a block copolymer of polyalkyl methacrylate and butyl acrylate, wherein the composition is a polyester resin composition applicable to laser welding. However, in the polyester resin composition according to Japanese Laid-Open Pub. No. 2010-70626, the compatibility between the PBT resin and an amorphous resin is insufficient, and the laser transmittance still requires improvement.

Japanese Laid-Open Pub. No. 2007-186584 discloses a polyester resin composition that provides excellent laser weldability and a molded product that is firmly bonded by laser welding. Its solution is as follows: the polyester resin composition is prepared by adding (b) 0 to 100 parts by weight of a reinforcing filler and (c) 0.1 to 100 parts by weight of an epoxy compound with respect to (a) 100 parts by weight of a polyester resin, and the polyester resin composition is applicable to laser welding. Although an epoxy resin is added into the composition, there is no mention of the addition of an epoxy resin with a special structure as used in our resin compositions or the improvement of the compatibility between the PBT resin and the amorphous polyester resin, and the polyester resin composition is insufficient in transmittance.

Chinese Patent Application Publication No. 1863870 A discloses a composition composed of a specific composition such as a polybutylene terephthalate resin, a polystyrene elastomer, a polycarbonate resin and a plasticizer. It achieves the effects of improving the transmittance uniformity and reducing the transmittance difference among different parts of a molded part, but it cannot greatly increase the transmittance (the transmittance under the laser condition of 940 nm is 20% to 34%).

Additionally, Japanese Laid-Open Pub. No. 2005-336409 discloses that in a polymer alloy formed by at least compounding a polybutylene terephthalate resin and polycarbonate, a molded product can be effectively used as a transmission material for a laser welding part by a method of controlling a phase structure. However, it does not mention the improvement of the compatibility between the PBT resin and the amorphous polyester resin, and therefore such a technology increases the transmittance to a limited extent.

### SUMMARY

We found that a polyester resin composition prepared by at least compounding (A) a polybutylene terephthalate resin, (B) an amorphous resin and (C) an epoxy resin with a special structure and adjusting the melting point to 210° C.-221° C., can acquire high laser transmittance. A molded product manufactured from the polyester resin composition can allow a laser to transmit through even when the laser power is small or the molded product has significant thickness. Therefore, the polyester resin composition is applicable to a laser-transmitting material of a laser welding part to allow it to be tightly combined with a laser-absorbent material. We thus provide:

1. A polyester resin composition, wherein the polyester resin composition is prepared by compounding at least the following (A) to (C):
(A) 100 parts by mass of a polybutylene terephthalate resin;
(B) 15 to 100 parts by mass of an amorphous resin; and
(C) 0.01 to 5 parts by mass of at least one epoxy resin selected from trisphenol methane epoxy resin, tetrakisphenol ethane epoxy resin, novolac epoxy resin and naphthalene epoxy resin; and by using a differential scanning calorimeter in a nitrogen environment, the polyester resin composition is cooled from a molten state to 20° C. at a cooling rate of 20° C./min and then heated at a heating-up rate of 20° C./min, wherein an endothermic peak during the heat-up occurs at the temperature of higher than 210° C. but lower than 221° C.

2. The polyester resin composition according to the above item 1, wherein the amorphous resin (B) is at least one selected from polycarbonate, amorphous polyester containing a cyclohexane dimethylene terephthalate unit or a styrene/acrylonitrile copolymer.

3. The polyester resin composition according to the above item 1, wherein the epoxy resin (C) is of a glycidyl ether structure or a glycidyl ester structure.

4. The polyester resin composition according to the above item 3, wherein the epoxy resin (C) is a novolac epoxy resin containing the glycidyl ether structure represented by general formula (1):

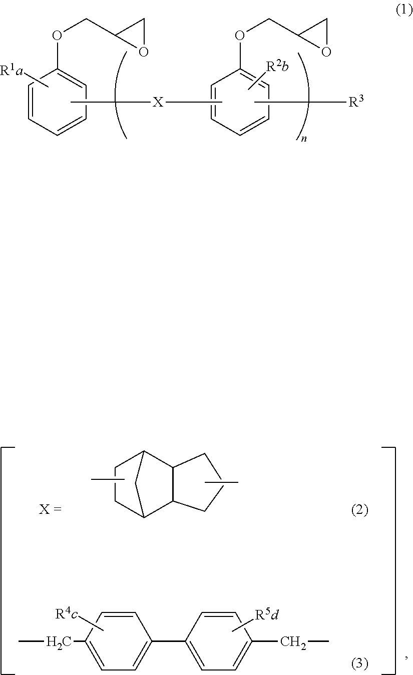

in general formula (1), X indicates a divalent group represented by general formula (2) or general formula (3); in general formulae (1) and (3), R¹, R², R⁴ and R⁵ are the same or different and each independently represent any one of an alkyl group having 1 to 8 carbon atoms, an aryl group having 6 to 10 carbon atoms or an alkyl ether group having 1 to 8 carbon atoms, and R³ indicates any one of a hydrogen atom, an alkyl group having 1 to 8 carbon atoms or an aryl group having 6 to 10 carbon atoms; in general formula (1), n indicates a value greater than 0 but less than or equal to 10; and in general formulae (1) and (3), a, c and d each independently represent integers of 0 to 4 while b is an integer of 0 to 3.

5. The polyester resin composition according to the above item 1, wherein the content of the epoxy resin (C) is 0.05 to 3 parts by mass with respect to 100 parts by mass of the polybutylene terephthalate resin (A).

6. The polyester resin composition according to the above item 1, wherein the polyester resin composition further comprises a filler material (D).

7. The polyester resin composition according to the above item 6, wherein the filler material (D) is at least one of glass fibers or carbon fibers.

8. The polyester resin composition according to the above item 6, wherein the content of the filler material (D) is 1 to 150 parts by mass with respect to 100 parts by mass of the polybutylene terephthalate resin (A).

9. The polyester resin composition according to the above item 1, wherein the polyester resin composition further comprises a transesterification inhibitor (E).

10. The polyester resin composition according to the above item 9, wherein the transesterification inhibitor (E) is a compound represented by general formula (4):

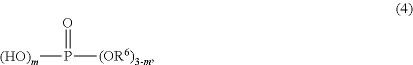

in general formula (4), R⁶ indicates an alkyl group having 1 to 30 carbon atoms, and m is 1 or 2.

11. The polyester resin composition according to the above item 9, wherein the content of the transesterification inhibitor (E) is 0.025 to 0.5 parts by mass with respect to 100 parts by mass of the polybutylene terephthalate resin (A).

12. The polyester resin composition according to the above item 1, wherein the polyester resin composition further comprises a nucleating agent (F).

13. The polyester resin composition according to the above item 12, wherein the nucleating agent (F) is at least one selected from the group consisting of silica, alumina, zirconia, titania, wollastonite, kaolin, talcum powder, mica, silicon carbide, ethylene bislauramide or a sorbitol derivative.

14. The polyester resin composition according to the above item 12, wherein the content of the nucleating agent (F) is 0.05 to 5 parts by mass with respect to 100 parts by mass of the polybutylene terephthalate resin (A).

15. The polyester resin composition according to the above item 1, wherein the polyester resin composition is molded under the conditions of a molding temperature of 260° C. and a mold temperature of 80° C. to prepare a molded piece with a thickness of 1 mm, which has the transmittance of more than 48% as measured with a spectrophotometer under the condition of a wavelength of 940 nm.

16. A molded product, which is made of the polyester resin composition according to any one of the above items 1 to 15.

17. The molded product according to the above item 16, wherein the molded product is a transmittable material for laser welding.

18. The molded product according to the above item 16, wherein a laser-transmitting portion of the molded product has a thickness of 3 mm or less.

The polyester resin composition due to its excellent laser transmittance can be used in various automotive electrical mounting components (various control units, various sensors, and the like), connectors, switch components, relay components, and the like.

### BRIEF DESCRIPTION OF THE DRAWINGS

FIG. 1(A) shows a top view and FIG. 1(B) shows a side view, which represent test samples for transmittance evaluation.

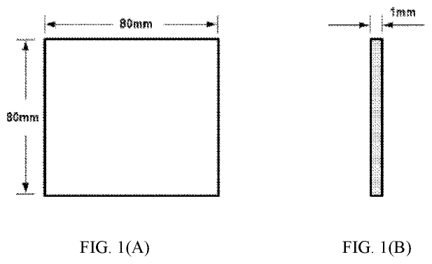

### DETAILED DESCRIPTION

A detailed description of our compositions and molded products will be illustrated below.

### (A) Polybutylene Terephthalate Resin

The (A) polybutylene terephthalate (PBT) resin as a matrix resin in the polyester resin composition may be exemplified as a homopolyester or copolyester taking butylene terephthalate as a main component.

Monomers that are copolymerizable in the copolyester may be exemplified as dicarboxylic acids other than a terephthalic acid, diols other than 1,4-butanediol, oxyacids or lactones, and the like. Copolymeric monomers may be used singly or in a combination of two or more thereof. Herein, the amount of the copolymeric monomers is preferably 30 mol % or less of the total amount of monomers.

The dicarboxylic acids other than the terephthalic acid may be exemplified as aliphatic dicarboxylic acids (e.g., glutaric acid, hexanedioic acid, pimelic acid, suberic acid, azelaic acid, sebacic acid, undecyl dicarboxylic acid, dodecyl dicarboxylic acid and hexadecyl dicarboxylic acid), alicyclic dicarboxylic acids (e.g., hexahydrophthalic acid, hexahydroisophthalic acid and hexahydroterephthalic acid), aromatic dicarboxylic acids (e.g., phthalic acid, isophthalic acid, 2,6-naphtha-lenedicarboxylic acid, 4,4′-diphenyldicarboxylic acid, 4,4′-diphenylether dicarboxylic acid, 4,4′-diphenylmethane dicarboxylic acid, 4,4′-diphenylketone dicarboxylic acid or other C8-16 dicarboxylic acids). Additionally, polycarboxylic acids such as trimellitic acid and pyromellitic acid may be mixed and used as needed.

The diols other than 1,4-butanediol may be exemplified as aliphatic alkylene glycols (e.g., ethylene The diols other than 1,4-butanediol may be exemplified as aliphatic alkylene glycols (e.g., ethylene glycol, propylene glycol, pentanediol, neopentyl glycol, hexanediol, heptanediol, octanediol, nonanediol, decanediol or other C2-12 alkanediols but preferably C2-10 alkanediols), polyalkoxy glycols (e.g., diethylene glycol, dipropylene glycol, dibutylene glycol, triethylene glycol, tripropylene glycol, polyethylene glycol, polypropylene glycol, polybutylene glycol or other oxyalkyl-containing glycols), aromatic diols (e.g., hydroquinone, resorcinol, naphthalenediol or other C6-C14 aromatic diols, biphenols, bisphenols, xylylene glycols), and the like. Additionally, polyhydric alcohols such as glycerol, trimethylolpropane, trimethylolethane or pentaerythritol may be mixed and used as needed.glycol, propylene glycol, pentanediol, neopentyl glycol, hexanediol, heptanediol, octanediol, nonanediol, decanediol or other C2-12 alkanediols but preferably C2-10 alkanediols), polyalkoxy glycols (e.g., diethylene glycol, dipropylene glycol, dibutylene glycol, triethylene glycol, tripropylene glycol, polyethylene glycol, polypropylene glycol, polybutylene glycol or other oxyalkyl-containing glycols), aromatic diols (e.g., hydroquinone, resorcinol, naphthalenediol or other C6-C14 aromatic diols, biphenols, bisphenols, xylylene glycols), and the like. Additionally, polyhydric alcohols such as glycerol, trimethylolpropane, trimethylolethane or pentaerythritol may be mixed and used as needed.

The oxyacids may be exemplified as hydroxy acids such as oxybenzoic acid, oxynaphthoic acid, hydroxyphenylacetic acid, glycolic acid or oxycaproic acid and derivatives thereof

The lactones may be exemplified as C3-12 lactones such as propiolactone, butyrolactone, valerolactone or caprolactone.

To take the properties with respect to moldability and laser transmittance into account, it is preferred that the inherent viscosity of the polybutylene terephthalate resin (A) measured in a solution of o-chlorophenol at 25° C. is 0.36-3.0 dl/g but more preferably 0.42-2.0 dl/g. One type of polybutylene terephthalate resin may be used but two or more polybutylene terephthalate resins with different inherent viscosities may also be used. However, it is preferable that their inherent viscosities be within the above ranges.

Meanwhile, to improve the compatibility between the polybutylene terephthalate resin (A) and the amorphous resin (B) as well as the laser transmittance, the carboxyl content of the polybutylene terephthalate resin (A) is preferably below 50 mol/ton. The carboxyl content of the polybutylene terephthalate resin (A) is obtained under the condition of titration with potassium hydroxide ethanolate after being dissolved in an o-cresol/chloroform solvent.

The polybutylene terephthalate resin (A) may be prepared by polymerizing a terephthalic acid or an ester-forming derivative thereof, 1,4-butanediol and a copolymeric monomer added as needed with a conventional method (e.g., transesterification, direct esterification, and the like).

### (B) Amorphous Resin

The amorphous resin (B) in the polyester resin composition may be exemplified as a styrene homopolymer/copolymer, aromatic polyethers (such as polyphenylene ether and polyetherimide), polycarbonate, polyarylester, polysulfone, polyethersulfone, polyimide or an amorphous polyester containing a cyclohexane dimethylene terephthalate unit, and the like.

The styrene homopolymer/copolymer may be exemplified as polystyrene, polychlorostyrene, poly α-methylstyrene, a styrene/chlorostyrene copolymer, a styrene/propylene copolymer, a styrene/acrylonitrile copolymer, a styrene/butadiene copolymer, a styrene/vinyl chloride copolymer, a styrene/vinyl acetate copolymer, a styrene/maleate copolymer, a styrene/acrylate copolymer (e.g., a styrene/methyl acrylate copolymer, a styrene/ethyl acrylate copolymer, a styrene/butyl acrylate copolymer, a styrene/octyl acrylate copolymer or a styrene/phenyl acrylate copolymer), a styrene/methacrylate copolymer (e.g., a styrene/methyl methacrylate copolymer, a styrene/ethyl methacrylate copolymer, a styrene/butyl methacrylate copolymer or a styrene/phenyl methacrylate copolymer), a styrene/α-methyl chloroacrylate copolymer or a styrene/acrylonitrile/acrylate copolymer.

The polycarbonate is prepared from one or more dihydroxy compounds, as a main raw material(s), selected from 2,2′-bis (4-hydroxyphenyl) propane (bisphenol A), 4,4′-dihydroxydiphenylalkane, 4,4′-dihydroxydiphenyl sulfone, 4,4′-dihydroxydiphenyl ether, 2,2′-bis (3,5-dimethyl-4-hydroxyphenyl) propane or 1,1′-bis (4-hydroxyphenyl) cyclohexane. Herein, the polycarbonate is preferably prepared by taking 2,2′-bis (4-hydroxyphenyl) propane (bisphenol A) as a main raw material.

As the polycarbonate prepared by taking the bisphenol A as the main raw material, other dihydroxy compounds for example 4,4′-dihydroxydiphenylalkane or 4,4′-dihydroxydiphenyl sulfone or 4,4′-dihydroxyphenyl ether (other than the bisphenol A) may also be copolymerized. The amount of other dihydroxy compounds used is preferably 10 mol % or less with respect to the total amount of the dihydroxy compounds.

The degree of polymerization of the polycarbonate is not specifically defined, but is intended to increase the compatibility between the polycarbonate (B) and the polybutylene terephthalate (A) and improve the moldability of the polycarbonate, the viscosity average molecular weight (Mv) of the polycarbonate (B) is preferably 10,000 to 50,000. The lower limit of the viscosity average molecular weight is more preferably 15,000 or more but even more preferably 18,000 or more. Additionally, the upper limit of the viscosity average molecular weight is more preferably 40,000 or less but even more preferably 35,000 or less.

The viscosity average molecular weight (Mv) is obtained by acquiring a limiting viscosity[η] (in dl/g) in a dichloromethane solvent at the temperature of 20° C. by using an Ubbelohde viscometer and further performing calculation according to the Schnell's viscosity formula[η]=1.23×10⁻⁴×(Mv)^{0.83}. The limiting viscosity[η] is calculated with formula (9) by using the specific viscosity[ηsp ]of the concentration[c] (g/dl) of each solution:

[η]limηsp/c(c→0) (⁹).

The amorphous polyester containing the cyclohexane dimethylene terephthalate unit refers to polyester obtained by polymerizing terephthalic acid-based dicarboxylic acid and 1,4-cyclohexanedimethanol and other diols.

Other diols include aliphatic alkylene glycols (e.g., ethylene glycol, propylene glycol, butylene glycol, pentanediol, neopentyl glycol, hexanediol, heptanediol, octanediol, nonanediol, decanediol or other C2-12 alkyl diols but preferably C2-10 alkyl diols), polyoxyalkylene diols (e.g., diols having an oxyalkylene unit such as diethylene glycol, dipropylene glycol, dibutylene glycol, triethylene glycol, tripropylene glycol, polyethylene glycol, polypropylene glycol and polybutylene glycol), alicyclic group diols (e.g., 1,2-cyclohexanediol, 1,3-cyclohexanediol, 1,4-cyclohexanediol, spirodiol, 1,3-cyclobutanediol, 2,2,4,4-tetramethyl-1,3-cyclobutanediol and pentacyclopentadecane dimethanol), aromatic diols (e.g., C6-C14 aromatic diols such as hydroquinone, resorcinol, naphthalene glycol, biphenols, bisphenols and xylene glycol), and the like.

A molar ratio [(I)/(II)] of the other diol units (I) to the 1,4-cyclohexanedimethanol unit (II) is between 1/99 and 99/1. From the standpoint of improving the compatibility with the polybutylene terephthalate (A),[(I)/(II)] is preferably less than 80/20, more preferably less than 75/25 but even more preferably less than 50/50. Meanwhile, [(I)/(II)] is preferably greater than 25/75, more preferably greater than 30/70.

Given the compatibility with the polybutylene terephthalate resin (A), the amorphous resin (B) is preferably at least one of polycarbonate, amorphous polyester containing a cyclohexane dimethylene terephthalate unit or a styrene/acrylonitrile copolymer.

The content of the amorphous resin (B) is 15 to 100 parts by mass with respect to 100 parts by mass of the polybutylene terephthalate (A). Within that range, the laser transmittance and the molding processability of the polyester resin composition may be improved. Furthermore, the lower limit of the content of the amorphous resin (B) is preferably 20 parts by mass or more but even more preferably 30 or more parts by mass. Meanwhile, the upper limit of the content is preferably 90 or fewer parts by mass but more preferably 80 or fewer parts by mass.

### (C) Epoxy Resin

The polyester resin composition comprises at least one epoxy resin (C) selected from trisphenol methane epoxy resin, tetrakisphenol ethane epoxy resin, novolac epoxy resin and naphthalene epoxy resin. From the standpoint of improving the compatibility effect among the components, the epoxy resin (C) preferably has a glycidyl ether structure or a glycidyl ester structure.

The novolac epoxy resin may be exemplified as a novolac epoxy resin having a glycidyl ether structure of formula (1):

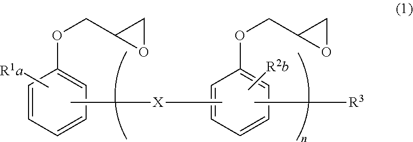

In the above structural formula (1), X represents a divalent group, which is represented by an alkyl, aryl, aralkyl or alicyclic hydrocarbon group having one to eight carbon atoms and may contain a plurality of groups. R¹ and R² may be the same or different. Each independently represents a hydrogen atom, an alkyl group having 1 to 8 carbon atoms, an aryl group having 6 to 10 carbon atoms or an alkyl ether group having 1 to 8 carbon atoms. R³ indicates a hydrogen atom, an alkyl group having one to eight carbon atoms or an aryl group having 6 to 10 carbon atoms. In the above structural formula (1), n represents a value greater than 0 but less than or equal to 20; a represents an integer of 0 to 4, and b is an integer of 0 to 3.

From the standpoint of high reactivity with a terminal carboxyl group of the polybutylene terephthalate resin (A) and low volatility, the epoxy resin (C) is preferably solid at room temperature (25° C.). From this, it is contemplated that the novolac epoxy resin having the glycidyl ether structure represented by the above structural formula (1) more preferably has the following structure:

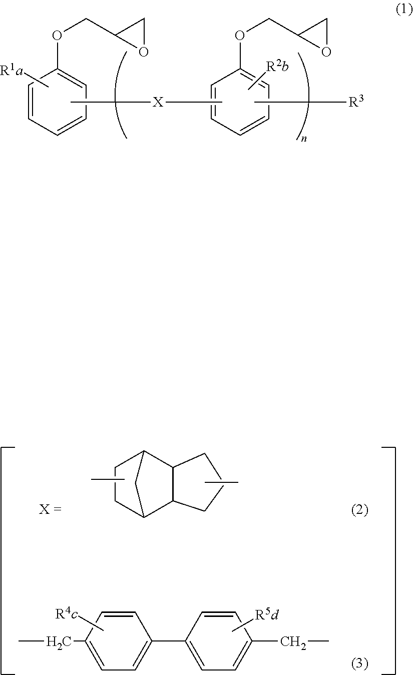

X preferably indicates a divalent group represented by general formula (2) or general formula (3); in general formulae (1) and (3), R¹ , R², R⁴ and R⁵ are the same or different and each independently represent any one of an alkyl group having 1 to 8 carbon atoms, an aryl group having 6 to 10 carbon atoms or an alkyl ether group having 1 to 8 carbon atoms, and R³ indicates any one of a hydrogen atom, an alkyl group having 1 to 8 carbon atoms or an aryl group having 6 to 10 carbon atoms; in general formula (1), n preferably indicates a value greater than 0 but less than or equal to 10; and in general formulae (1) and (3), a, c and d each independently represent integers of 0 to 4 while b is an integer of 0 to 3.

Additionally, the trisphenol methane epoxy resin has a structure shown in structural formula (5); the tetrakisphenol ethane epoxy resin has a structure shown in structural formula (6); and the naphthalene epoxy resin has structures shown in structural formulae (7) and (8):

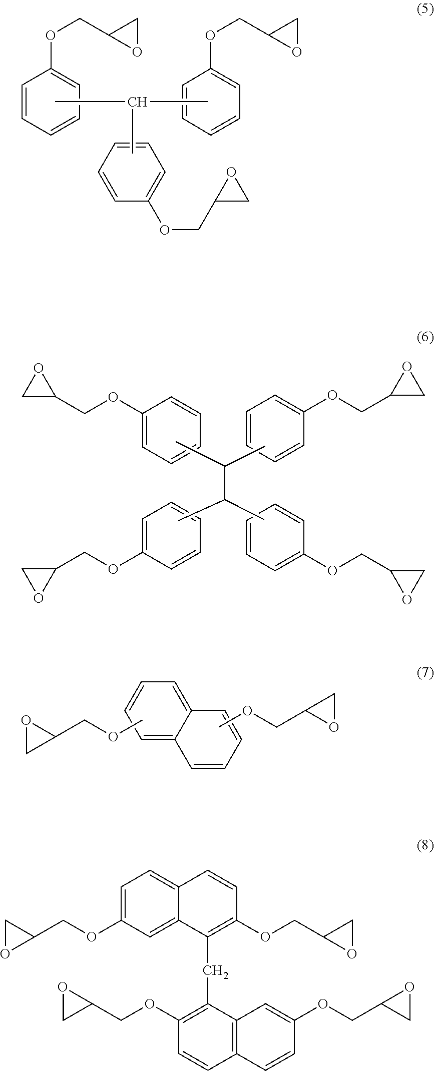

An epoxy value of the above epoxy compounds is preferably 100-1,000 g/eq. Within this range, the polyester resin composition may be suppressed from generating a gas during melt processing and, at the same time, may effectively react with a carboxyl group of the polybutylene terephthalate (A). Furthermore, the lower limit of the epoxy value is more preferably 200 g/eq or more. Additionally, the upper limit of the epoxy value is more preferably 500 g/eq or less but even more preferably 400 g/eq or less.

The content of the epoxy resin (C) is 0.010 to 5.0 parts by mass with respect to 100 parts by mass of the polybutylene terephthalate resin (A). When the epoxy resin is 0.010 parts by mass or more, the compatibility between the polybutylene terephthalate (A) and the amorphous resin (B) is improved, thereby increasing the transmittance. When the content of the epoxy resin (C) is 5.0 or fewer parts by mass, the epoxy resin (C) in the polyester composition has good dispersibility, thereby increasing the transmittance. Furthermore, the lower limit of the content of the epoxy resin (C) is preferably 0.050 parts by mass or more but even more preferably 0.10 parts by mass or more but even more preferably 0.40 or more parts by mass. Additionally, the upper limit of the content of the epoxy resin (C) is preferably 3.0 or fewer parts by mass but more preferably 1.5 or fewer parts by mass.

### (D) Filler Material

A filler material (D) may be further added into the polyester resin composition. The filler material (D) is not specifically defined as long as it is a filler material commonly used in known resins. For example, glass fibers, carbon fibers, potassium titanate whiskers, zinc oxide whiskers, aluminum borate whiskers, aromatic polyamide fibers, alumina fibers, silicon carbide fibers, ceramic fibers, asbestos fibers, gypsum fibers, metal fibers, glass flakes, wollastonite, zeolite, sericite, kaolin, mica, talcum powder, clay, pyrophyllite, bentonite, montmorillonite, hectorite, synthetic mica, asbestos, graphite, aluminosilicate, alumina, silicon dioxide, magnesium oxide, zirconium oxide, titanium oxide, iron oxide, calcium carbonate, magnesium carbonate, dolomite, calcium sulfate, barium sulfate, magnesium hydroxide, calcium hydroxide, aluminum hydroxide, glass beads, hollow glass beads, ceramic beads, boron nitride, silicon carbide or wollastonite and the like may be used. The filler material may also be a structurally hollow filler material, but two or more of these filler materials may be selected and used in combination. The average diameter of the filler material is not specifically defined but is preferably 0.001-20 μm to obtain a better appearance for the polyester resin composition.

Particularly, in comprehensive consideration of low molding shrinkage and high fluidity, the filler material is preferably at least one of the glass fibers or the carbon fibers to acquire a polyester resin composition with excellent performances. The glass fibers are not specifically defined but may be those used in the prior art. The glass fibers may be fibers in the shape of chopped strands cut to length, coarse sand or ground fibers. Generally, the average diameter of the glass fibers preferably used is 5 to 15 μm. In using the chopped strands, the length is not specifically defined, but it is preferable to use the fibers having a standard length of 3 mm, which are suitable for extrusion and mixing operations. Additionally, the cross-sectional shape of the above-mentioned fibrous filler material is not specifically defined. Therefore, any one or more of round or flat fibers may be selected and used in combination.

Considering the balance between rigidity and toughness of the polyester resin composition, the content of the filler material (D) is preferably 1 to 150 parts by mass with respect to 100 parts by mass of the polybutylene terephthalate (A). Additionally, the lower limit of the filler material (D) is more preferably 10 parts by mass or more but even more preferably 30 or more parts by mass. An upper limit of the filler material (D) is more preferably 100 or fewer parts by mass but even more preferably 80 or fewer parts by mass.

### (E) Transesterification Inhibitor

In the polyester resin composition, a transesterification inhibitor (E) may be further added. The transesterification inhibitor is a compound that may be used to deactivate a transesterification catalyst contained in the polybutylene terephthalate resin (A). It is not specifically defined, but phosphite and phosphate compounds are preferred.

As the phosphite compound, one or more of triphenyl phosphite, trinonyl phenyl phosphite, tricresyl phosphite, trimethyl phosphite, triethyl phosphite, tris (2-ethylhexyl)phosphite, tridecyl phosphite, tris (dodecyl) phosphite, tris (tridecyl) phosphite, trioleyl phosphite, 2-ethylhexyl diphenyl phosphite, diphenyl monodecyl phosphite, diphenyl mono (tridecyl) phosphite, phenyl didecyl phosphite, tris (dodecyl) trithiophosphite, diethyl phosphite, bis (2-ethylhexyl) phosphite, bis (dodecyl) phosphite, dioleoyl hydrogen phosphite, diphenyl phosphite, tetraphenyldipropylene glycol diphosphite, tetrakis (C12-C15 alkyl)-4,4′-isopropylidene diphenyl diphosphite, 4,4′-butylene bis-(3-methyl-6-tert-butylphenyl) -tetrakis(tridecyl) diphosphite, bis (decyl) pentaerythritol diphosphite, bis (tridecyl) pentaerythritol diphosphite, tris (octadecyl) phosphite, bis (octadecyl) pentaerythritol diphosphite, tris (2,4-di-tert -butylphenyl) phosphite, hydrogenated bisphenol A phenol phosphite polymer, tetraphenyltetrakis (tridecyl) pentaerythritol tetraphosphite, tetrakis (tridecyl) 4,4′-isopropylene diphenyl diphosphite, bis (nonylphenyl) pentaerythritol diphosphite, dilauryl pentaerythritol diphosphate, tris (4-tert -butylphenyl) phosphite, tris (2,4-di-tert-butylphenyl) phosphite, hydrogenated bisphenol A pentaerythritol phosphite polymer, bis (2,4-Di-tert-butylphenyl) pentaerythritol diphosphite, bis (2,6-di-tert-butyl-4-methylphenyl) pentaerythritol diphosphite, bis (2-tert-butylphenyl)phenyl phosphite, bis (2,4,6-tri-tert-butylphenyl) pentaerythritol diphosphite, 2,2′-methylene bis (4,6-di -tert-butylphenyl)-2-ethylhexyl phosphite, 2,2′-methylene bis (4,6-di-tert-butylphenyl) octyl phosphite, bis (2,4-dicumylphenyl) pentaerythritol diphosphite or tetrakis (2,4-di-tert -butylphenyl)-4,4′-biphenylene diphosphite and other compounds is/are preferred.

Besides, the phosphate compound is preferably a compound exemplified and represented by general formula (4):

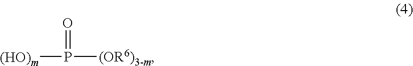

In general formula (4), R⁶ indicates an alkyl group having one to 30 carbon atoms, and m is 1 or 2.

The compound represented by general formula (4) may be specifically exemplified as methyl phosphate, dimethyl phosphate, ethyl phosphate, diethyl phosphate, isopropyl phosphate, diisopropyl phosphate, butyl phosphate, dibutyl phosphate, butoxyethyl phosphate, dibutoxyethyl phosphate, 2-ethyl hexanoate phosphate, di-2-ethyl hexanoate phosphate, octyl phosphate, dioctyl phosphate, isodecyl phosphate, diisodecyl phosphate, isotridecyl phosphate, diisotridecyl phosphate, n-dodecyl phosphate, di (dodecyl) phosphate), octadecyl phosphate, di(octadecyl) phosphate, tetracosyl phosphate, bis (tetracosyl) phosphate, oleate phosphate, dioleate phosphate, and the like. Among them, the phosphate compound is more preferably octadecyl phosphate or di (octadecyl) phosphate. These phosphate compounds may be used singly or in a combination of two or more thereof. Additionally, the phosphate compounds listed above may also be used as a metal salt that is formed together with zinc, aluminum or the like.

For the catalyst deactivation of the transesterification reaction, the use of the phosphate compound shows a higher deactivation rate than that of the phosphite compound. Therefore, the phosphate compound is preferred. Because the transesterification inhibitor (E) may cause the polybutylene terephthalate resin (A) to decompose if added in excess, the content of the transesterification inhibitor (E) is preferably 0.025 to 0.5 parts by mass with respect to 100 parts by mass of the polybutylene terephthalate resin (A). Moreover, the lower limit of the content of (E) is more preferably 0.03 or more parts by mass but even more preferably 0.1 or more parts by mass. Meanwhile, the upper limit of the content of (E) is more preferably 0.3 or fewer parts by mass but even more preferably 0.25 or fewer parts by mass.

### (F) Nucleating Agent

The nucleating agent (F) used as a crystallization accelerator in the polyester resin composition is not specifically defined, and therefore a substance generally used as a crystallization nucleating agent for a polymer is satisfactory. The nucleating agent (F) may be any one or more selected from inorganic crystallization nucleating agents or organic crystallization nucleating agents.

The inorganic crystallization nucleating agent may be exemplified as silica, alumina, zirconia, titania, wollastonite, kaolin, talcum powder, mica, silicon carbide, and the like.

Additionally, aliphatic carboxylamide, sorbitol derivatives and the like may be used as the organic crystallization nucleating agents. The aliphatic carboxylamide may be exemplified as an aliphatic monocarboxylic acid amide such as lauroylamide, palmitamide, oleamide, stearamide, erucylamide, behenamide, ricinolamide or hydroxy stearamide; N-substituted aliphatic monocarboxyl amides such as N-oleyl palmitamide, N-oleyl oleamide, N-oleyl stearamide, N-stearyl oleamide, N-stearyl stearamide, N-stearyl erucylamide, N-hydroxymethyl steariamide or N-hydroxymethyl behenamide; an aliphatic bis-carboxylamide such as methylene bis stearamide, ethylene bis-lauroamide, ethylidene bis-decanoylamide, ethylidene bis-ole amide, ethylidene bis steariamide, ethylidene bis-erucylamide, ethylidene bis-behenamide, ethylidene bis-isostearamide, ethylidene bishydroxy stearamide, butylidene bis steariamide, hexamethylene bis-oleamide, hexamethylene bis stearamide, hexamethylene bisbehenamide, hexamethylene bis-hydroxy stearamide, m-xylylene bis stearic amide or m-xylylene bis-12-hydroxy steariamide; an N-substituted aliphatic carboxyldiamide such as N,N′-dioleyl decanodiamide, N,N′-dioleyl adipamide, N,N-distearyl adipamide, N,N′-distearyl decanodiamide, N,N′-distearyl m-phthalamide or N,N′-distearyl terephthalic amide; and an N-substituted urea such as N-butyl-N′-stearyl urea, N-propyl-N′-stearyl urea, N-stearyl-N′-stearyl urea, N-phenyl-N′-stearyl urea, xylylene bis stearyl urea, tolyl bis stearyl urea, hexamethylene bis stearyl urea, diphenylmethane bis stearyl urea or diphenylmethane dilauryl urea.

The sorbitol derivatives may be exemplified as, for example, bis (benzylidene) sorbitol, bis (p-methylbenzylidene) sorbitol, bis (p-ethylbenzylidene) sorbitol, bis (p-chlorobenzylidene) sorbitol, bis (p-bromobenzylidene) sorbitol or sorbitol derivatives obtained by chemical modification of the above-mentioned sorbitol derivatives, and the like.

Considering the effect of promoting the crystallization of the polybutylene terephthalate resin (A), the nucleating agent (F) is preferably at least one selected from the group consisting of silica, alumina, zirconia, titania, wollastonite, kaolin, talcum powder, mica, silicon carbide, ethylene bislauramide or a sorbitol derivative. Moreover, the content of the nucleating agent (F) is preferably 0.05 to 5 parts by mass with respect to 100 parts by mass of the polybutylene terephthalate resin (A). Within this range of mass, the effect of promoting crystallization may be maintained and laser transmittance may be improved. The content of the nucleating agent (F) is more preferably 0.1 or more parts by mass but is even more preferably three or fewer parts by mass but even more preferably two or fewer parts by mass.

### (G) Other Additives

In addition to the components (A) to (F), the polyester resin composition may further include additives such as an antioxidant, a mold-releasing agent, a flame retardant or color master batches.

The antioxidant is preferably at least one of a phenolic antioxidant or a sulfur antioxidant. To achieve better heat resistance and higher thermal stability, the combined use of the phenol-based antioxidant and the sulfur antioxidant is preferred.

The phenolic antioxidant may be exemplified as, for example, 2,4-dimethyl-6-tert -butylphenol, 2,6-di-tert-butylphenol, 2,6-di-tert-butyl-p-cresol, 2,6-di-tert-butyl-4-ethylphenol, 4,4′-butylene bis (6-tert-butyl-3-methylphenol), 2,2′-methylene bis (4-methyl 6-tert-butylphenol), 2,2′-methylene-bis (4-ethyl-6-tert-butylphenol), octadecyl-3-(3′,5′-di-tert-butyl-4′-hydroxybenzene) propionate, pentaerythritol tetrakis[3-(3,5-di-tert-butyl-4-hydroxybenzene)]propionate], 1,1,3-tris (2-methyl-4-hydroxy-5-di-tert-butylphenyl) butane, tris (3,5-di-tert-butyl-4-hydroxybenzl) isocyanurate, triethylene glycol-bis[3(3-tert-butyl-4-hydroxy-5-methylbenzene) propionate], 1,6-hexanediol bis[3 -(3,5-di-tert-butyl-4-hydroxyphenyl) propionate], 2,4-bis (n-octylthio)-6-(4-hydroxy-3,5-di-tert-butylanilino)-1,3,5-triazine, 2,2-thiodiethylene bis[3-(3,5-di-tert-butyl-4-hydroxybenzene) propionate], N,N′-hexamethylene bis(3,5-di-tert-butyl-4-hydroxyhydrocinnamon amide), 3,5-di-tert-butyl-4-hydroxybenzyl diethyl phosphite, 1,3,5-trimethyl-2,4,6-tris (3,5-di-tert-butyl-4-hydroxybenzyl) benzene, tris (3,5-di-tert-butyl-4-hydroxybenzyl) isocyanurate, 2,4-bis[(octylthio)methyl]o-cresol or isooctyl-3-(3,5-di-tert-butyl-4-hydroxybenzene) propionate, and the like.

The sulfur antioxidant may be exemplified as, for example, dilauryl thiodipropionate, dimyristyl thiodipropionate, distearyl thiodipropionate, bis (tridecane) thiodipropionate, pentaerythryl(3-lauryl thiopropionate) or 2-mercapto benzimidazole, and the like.

The above-mentioned antioxidants may be used singly but may also be used in combination of more thereof, since a synergistic effect would be produced by combining two or more antioxidants.

The content of the antioxidant is preferably 0.01 to 3 parts by mass with respect to the total of 100 parts by mass of the polybutylene terephthalate (A) and the amorphous resin (B). Within this range, an anti-oxidation effect may be maintained, and a gas may be suppressed from being generated during melt processing. The content is more preferably 0.05 or more parts by mass but even more preferably 0.1 or more parts by mass. Additionally, the content is preferably two or fewer parts by mass but even more preferably one or fewer parts by mass.

The mold-releasing agent is not specifically defined, and any mold-releasing agent for general thermoplastic resins may be used. Specifically, the mold-releasing agent may be exemplified as fatty acid, fatty acid metal salt, hydroxy fatty acid, fatty acid ester, aliphatic partially saponified ester, paraffin, low-molecular-weight polyolefin, fatty acid amide, alkylene fatty acid bis-amide, aliphatic ketone, fatty acid lower alcohol ester, fatty acid polyol ester, fatty acid polyglycol ester or modified polysiloxane, and the like.

The fatty acid is preferably a fatty acid having 6 to 40 carbon atoms and may be specifically exemplified as oleic acid, lauric acid, stearic acid, hydroxystearic acid, behenic acid, arachidonic acid, linoleic acid, linolenic acid, ricinoleic acid, palmitic acid, stearic acid, montanic acid or a mixture thereof.

The fatty acid metal salt is preferably a fatty-acid alkali metal salt or alkaline earth metal salt having 6 to 40 carbon atoms and may be specifically exemplified as calcium stearate, sodium montanate or calcium montanate, and the like.

The hydroxy fatty acid may be exemplified as 1,2-hydroxy fatty acid, and the like.

The fatty acid ester may be exemplified as stearate, oleate, linoleate, linolenate, adipate, behenate, arachidonate, montanate, isostearate or polymeric acid ester, and the like.

The aliphatic partially saponified ester may be exemplified as partially saponified montanate.

The paraffin preferably has 18 or more carbon atoms and may be exemplified as liquid paraffin, natural paraffin, microcrystalline wax or petrolatum, and the like.

The low-molecular-weight polyolefin preferably has a weight-average molecular weight of 5,000 or less and may be specifically exemplified as polyethylene wax, maleic acid-modified polyethylene wax, oxidized polyethylene wax, chlorinated polyethylene wax or polypropylene wax.

The fatty acid amide preferably has six or more carbon atoms and may be specifically exemplified as oleamide, erucylamide or behenic amide, and the like.

The alkylene bis-fatty acid amide preferably has six or more carbon atoms and may be specifically exemplified as methylene bis stearamide, ethylene bis stearamide or N,N-bis (2-hydroxylethyl) stearamide, and the like.

The aliphatic ketone may be exemplified as higher aliphatic ketone, and the like.

The fatty acid low alcohol ester preferably has six or more carbon atoms and may be specifically exemplified as ethyl stearate, butyl stearate, ethyl behenate or rice wax, and the like.

The fatty acid polyol ester may be exemplified as glycerol monostearate, pentaerythritol monostearate, pentaerythritol tetrastearate, pentaerythritol adipate stearate, dipentaerythritol adipate stearate or sorbitan monobehenate, and the like.

The fatty acid polyglycol ester may be exemplified as polyethylene glycol fatty acid ester or polypropylene glycol fatty acid ester.

The modified polysiloxane may be exemplified as methyl styryl-modified polysiloxane, polyether-modified polysiloxane, high fatty acid alkoxy-modified polysiloxane, higher fatty acid-containing polysiloxane, high fatty acid ester-modified polysiloxane, methacrylic acid-modified polysiloxane or fluorine-modified polysiloxane, and the like.

The flame retardant may be exemplified as a bromine-based flame retardant, including decabromodiphenyl ether, octabromodiphenyl ether, tetrabromodiphenyl ether, tetrabromophthalic anhydride, hexabromocyclododecane, bis (2,4,6-tribromophenoxy)=ethane, ethylenebistetrabromophthalimide, hexabromobenzene, 1,1-sulfonyl[3,5-dibromo-4-(2,3-dibromopropoxy)]benzene, polydibromophenylene oxide, tetrabromobisphenol-S, tris (2,3-dibromopropyl) isocyanurate, tribromophenol, tribromophenylallyl ether, tribromoneopentyl alcohol, brominated polystyrene, brominated polyethylene, tetrabromobisphenol-A, tetrabromobisphenol-A derivatives, brominated epoxy resins such as tetrabromobisphenol-A-epoxide oligomers or polymers and brominated phenol linear phenolic varnish epoxides, tetrabromobisphenol-A-carbonate oligomers or polymers, tetrabromobisphenol-A-bis (2-hydroxydiethyl ether), tetrabromobisphenol-A-bis (2,3-dibromopropyl ether), tetrabromobisphenol-A-bis (allyl ether), tetrabromocyclooctane, ethylene bis-pentabromodiphenyl, tris (tribromoneopentyl) phosphate, poly (pentabromobenzyl polyacrylate), octabromotrimethylphenyl dihydroindene, dibromoneopentyl glycol, pentabromobenzyl polyacrylate, dibromotolyl glycidyl ether or N,N′-ethylene-bis-tetrabromoterephthalimide, and the like. In the present invention, the flame retardant described above may also be exemplified as a chlorine-based flame retardant, including chlorinated paraffin, chlorinated polyethylene, perchlorocyclopentadecane or tetrachlorophthalic anhydride, and the like.

For the polyester resin composition, with a differential scanning calorimeter in a nitrogen environment, the polyester resin composition is cooled from a molten state to 20° C. at a cooling rate of 20° C./min and then heated at a heating-up rate of 20° C./min, wherein an endothermic peak during the heat-up occurs at the temperature of higher than 210° C. but lower than 221° C. By controlling the endothermic peak temperature within this range, the compatibility between the polybutylene terephthalate resin (A) and the amorphous resin (B) is improved, the transmittance is improved and the polyester resin composition with excellent heat resistance may be obtained. Furthermore, the upper limit of the endothermic peak temperature is preferably 220° C. or lower but more preferably 219° C. or lower. Meanwhile, the lower limit of the endothermic peak temperature is preferably 215° C. or higher but more preferably 217° C. or higher.

The polyester resin composition may be produced by the following production method: The main components (A), (B), (C) and the components (E), (F) and the like added as needed are mixed in a commonly used melt mixer such as a single-screw or twin-screw extruder, a Banbury mixer, a kneader and a mixer in accordance with corresponding melt-mixing methods.

The polyester resin composition may be prepared by injection molding, extrusion molding and other methods to obtain a molded product.

In injection molding, the mold temperature is preferably more than 40° C. but less than 250° C., and it is contemplated that the advantages of high molding efficiency and good appearance of the molded product may be achieved when the curing is performed in a temperature range of more than the glass transition temperature but less than the melting point of the polybutylene terephthalate resin (A). Therefore, the mold temperature is preferably more than 60° C. but less than 140° C.

The polyester resin composition is molded under the conditions of a molding temperature of 260° C. and a mold temperature of 80° C. to prepare a molded product with a thickness of 1 mm, which has the transmittance of preferably more than 48% as measured with a spectrophotometer under the condition of a wavelength of 940 nm. The molded product has high transmittance and may be used as a transmission material for laser welding. The transmittance here refers to a value measured by the spectrophotometer with an integrating sphere as a detector.

Although the thickness of the molded product is not specifically defined, the thickness of the laser transmitting portion of the molded product is preferably 3 mm or less from the standpoint of improving the transmittance.

### EXAMPLES

Our compositions and molded products will be further illustrated in the following examples, which are provided here merely for the purpose of illustration rather than limiting the range thereof. Raw materials and test devices as used in the following examples are shown herein:

### 1. Raw Materials of Polyester Resin Composition

(A) Polybutylene terephthalate resin

Polybutylene terephthalate resin (PBT): from Toray Industries Inc., with the intrinsic viscosity of 0.76 dl/g and the terminal carboxyl concentration of 15 mol/ton

(B) Amorphous resin

Polycarbonate (PC): S1000, from Mitsubishi Engineering-Plastics Corporation

Cyclohexanedimethylene terephthalate/ethylene terephthalate copolymer (PCTG): Eastar EB062, from Eastman Chemical Company, USA

(C) Epoxy resin

HP-7200H from DIC Corporation (a novolac epoxy resin with an aromatic glycidyl ether structure, with an epoxy value of 280 g/eq)

HP4700 from DIC Corporation (a naphthalene epoxy resin with an aromatic glycidyl ether structure, with an epoxy value of 160 g/eq)

Hexion Cardura E10P (branched alkane glycidyl carboxylate, with an epoxy value of 244 g/eq)

JER1009 from Mitsubishi Chemical Corporation (bisphenol A epoxy resin, with an epoxy value of 2,950 g/eq)

(D) Filler material

Glass fibers: T187 from Nippon Electric Glass Corporation

(E) Transesterification inhibitor

AX71 (a mixture of distearic acid phosphate and stearic acid phosphate) from ADEKA Corporation

(F) Nucleating agent

Nucleating agent 1: Hightron (talcum powder) from Takehara Chemical Industry Corporation

Nucleating agent 2: Ethylene bislauramide (EBL) from Guangzhou Ouying Chemical Co., Ltd.

2. Performance tests of polyester resin composition obtained in the Examples and Comparative Examples
(1) Transmittance test

The transmittance was evaluated by using an ultraviolet near-infrared spectrophotometer (UV-3100) manufactured by Shimadzu Corporation. Additionally, an integrating sphere was used as a detector. For transmittance, the light transmittance of a sample with a thickness of 1 mm was measured in a near-infrared region at the wavelength of 940 nm, and a ratio of the amount of transmitted light to the amount of incident light was expressed in percentage in the table. For the measurement of transmittance in the near-infrared region at the wavelength of 940 nm, the transmittance was measured every 10 nm, and the maximum and minimum transmittances in the near-infrared region at the wavelength of 940 nm were determined. The measurement was performed five times to determine the average value of the upper limit and the lower limit.

(2) Melting point (Tm) test

With a differential scanning calorimeter (DSC250) from TA Company, the polyester resin composition prepared in each of the Examples and Comparative Examples was accurately weighed to 5-7 mg and then heated at a heating-up rate of 20° C/min in a nitrogen atmosphere from 20° C. to a temperature 30° C. higher than the temperature T0 of an endothermic peak that appeared; the polyester resin composition was maintained at this temperature for two minutes and then cooled to 20° C. at a cooling rate of 20° C./min; and the polyester resin composition was maintained at 20° C. for two minutes and then heated again at a heating-up rate of 20° C./min to a temperature 30° C. higher than T0, thereby obtaining the melting point Tm. Tm indicates the temperature corresponding to a tip of the endothermic peak during the secondary heating process.

### Examples 1 to 7

The raw materials as shown in Table 1 were molten and mixed by using a TEX30α twin-screw extruder (L/D=45.5) manufactured by Japan Steel Works, Ltd. The extruder was provided with 13 heating zones and two sets of feeding apparatuses with measuring instruments and was also provided with a vacuum exhaust device. In addition to glass fibers, other raw materials were mixed and then added from a main feeding port of the extruder, and the glass fibers were added from a side feeding port of the extruder. The temperature of the extruder was set within the range of 100° C. to 260° C. All the materials were molten and mixed, cooled and granulated to obtain a granular polyester resin composition. The granules were dried in an oven at 130° C. for three hours and then subjected to injection molding by using a NEX50 injection molding machine manufactured by Nissei Plastic Industrial Co., Ltd. under the conditions of a molding temperature of 260° C. and a mold temperature of 80° C., to obtain a sample piece for transmittance evaluation (with a sample mold having the dimensions of 80 mm in length×80 mm in width×1 mm in thickness). The test piece was tested based on the above-mentioned transmittance and melting point test methods, with the test results shown in Table 1.

### Comparative Examples 1 to 10

A preparation method is the same as that in Example 1, the raw materials are shown in Table 2, and the test is conducted based on the above-mentioned transmittance and melting point test methods, with the test results shown in Table 2.

TABLE 1

| Component | | Unit | Example 1 | Example 2 | Example 3 | Example 4 | Example 5 | Example 6 | Example 7 |
|---|---|---|---|---|---|---|---|---|---|
| PBT | | Parts by mass | 100 | 100 | 100 | 100 | 100 | 100 | 100 |
| PC | S1000 | Parts by mass | 25 | 25 | 33.3 | 33.3 | 81.8 | 33.3 | |
| PCTG | EB062 | Parts by mass | | | | | | | 57.5 |
| Epoxy resin | HP-7200H | Parts by mass | 2.14 | 0.714 | 0.762 | 0.762 | 1.04 | | 0.92 |
| | HP4700 | | | | | | | 0.762 | |
| GF | T187 | Parts by mass | 53.6 | 53.6 | 57.1 | 57.1 | 77.9 | 57.1 | 69 |
| Transesterification | AX71 | Parts by mass | 0.179 | 0.179 | 0.19 | 0.19 | 0.26 | 0.19 | 0.057 |
| inhibitor | | | | | | | | | |
| Nucleating | Hightron | Parts by mass | 0.446 | | | 0.476 | 0.65 | 0.476 | |
| agent | EBL | Parts by mass | | 0.446 | | | | | |

| | | | | | | | | |
|---|---|---|---|---|---|---|---|---|
| Tm | ° C. | 220 | 219 | 218 | 218 | 217 | 218 | 220 |
| Transmittance at 1 mmt | % | 49 | 55 | 54 | 51 | 74 | 50 | 63 |

TABLE 2

| | | | Com- | Com- | Com- | Com- | Com- | Com- | Com- | Com- | Com- | Com- |
|---|---|---|---|---|---|---|---|---|---|---|---|---|
| | | | parative | parative | parative | parative | parative | parative | parative | parative | parative | parative |
| Com- | | | Ex- | Ex- | Ex- | Ex- | Ex- | Ex- | Ex- | Ex- | Ex- | Ex- |
| ponent | | Unit | ample 1 | ample 2 | ample 3 | ample 4 | ample 5 | ample 6 | ample 7 | ample 8 | ample 9 | ample 10 |
| PBT | | Parts | 100 | 100 | 100 | 100 | 100 | 100 | 100 | 100 | 100 | 100 |
| | | by | | | | | | | | | | |
| | | mass | | | | | | | | | | |
| PC | S1000 | Parts | | | 11.1 | 25 | 25 | 11.1 | 25 | 25 | 33.3 | 33.3 |
| | | by | | | | | | | | | | |
| | | mass | | | | | | | | | | |
| Epoxy | HP- | Parts | | 1.43 | | | 0.0089 | 0.635 | 0.714 | 5.36 | | |
| resin | 7200H | by | | | | | | | | | | |
| | | mass | | | | | | | | | | |
| | Cardura | Parts | | | | | | | | | 0.762 | |
| | E10P | by | | | | | | | | | | |
| | | mass | | | | | | | | | | |
| | JER1009 | Parts | | | | | | | | | | 0.762 |
| | | by | | | | | | | | | | |
| | | mass | | | | | | | | | | |
| GF | T187 | Parts | 42.9 | 42.9 | 47.6 | 53.6 | 53.6 | 47.6 | 53.6 | 53.6 | 57.1 | 57.1 |
| | | by | | | | | | | | | | |
| | | mass | | | | | | | | | | |
| Trans- | AX71 | Parts | | | 0.159 | 0.179 | 0.179 | 0.159 | 0.179 | 0.179 | 0.19 | 0.19 |
| esterifi- | | by | | | | | | | | | | |
| cation | | mass | | | | | | | | | | |
| inhibitor | | | | | | | | | | | | |
| Nucle- | Hightron | Parts | | | | 0.446 | 0.446 | | 0.446 | 0.446 | 0.476 | 0.476 |
| ating | | by | | | | | | | | | | |
| agent | | mass | | | | | | | | | | |
| | EBL | Parts | | | | | | | | | | |
| | | by | | | | | | | | | | |
| | | mass | | | | | | | | | | |
| Tm | | ° C. | 224 | 223 | 224 | 223 | 223 | 222 | 222 | 217 | 222 | 222 |
| Trans- | | % | 27 | 27 | 31 | 35 | 35 | 41 | 45 | 42 | 47 | 45 |
| mittance | | | | | | | | | | | | |
| at 1 mmt | | | | | | | | | | | | |

As can be seen from a comparison between the Examples 1-7 and the Comparative Examples 1-4, in the polybutylene terephthalate resin (A), the amorphous resin (B) and the specific epoxy resin (C) as the specific components are satisfactory and the requirement that the melting point of the composition (under the test conditions specified by DSC) is higher than 210° C. but lower than 221° C. is met, the transmittance (>48%) of the resin composition is far higher than that of the resin composition that does not meet the above conditions at the same time.

As can be seen from the comparison between Example 1 and Comparative Examples 5 and 8, the transmittance of the polyester resin composition is poor when the content of the specific epoxy resin (C) is too much or too little.

As can be seen from the comparison between Example 1 and Comparative Examples 5 and 8, the transmittance of the polyester resin composition is poor when the content of the specific epoxy resin (C) is too much or too little.

From the comparison among Example 4, Comparative Example 9 and Comparative Example 10, the transmittance of the polyester resin composition with the addition of the epoxy resin (HP-7200H) is higher than that of polyester resin composition with the addition of the epoxy resin Cardura ElOP or JERI009. It indicates that high transmittance may be achieved by adding the epoxy resin of our specific structure.

As can be seen from the comparison between Example 1 and Comparative Example 7, in addition to the specific contents of the polybutylene terephthalate resin (A), the amorphous resin (B) and the specific epoxy resin (C), the effect of improving the transmittance according to our resin compositions can also be achieved by allowing the melting point of the resin composition to be within our specific range.

Additionally, as can be seen from the comparisons between Example 3 and Example 4 and between Comparative Example 7 and Example 2, the addition of the nucleating agent and the type of the nucleating agent will affect the compatibility between (A) and (B) in the polyester resin composition as well as the transmittance.

1-18. (canceled)

19. A polyester resin composition, wherein the polyester resin composition is prepared by compounding at least (A) to (C):
(A) 100 parts by mass of a polybutylene terephthalate resin,
(B) 15 to 100 parts by mass of an amorphous resin, and
(C) 0.01 to 5.0 parts by mass of at least one epoxy resin selected from trisphenol methane epoxy resin, tetrakisphenol ethane epoxy resin, novolac epoxy resin and naphthalene epoxy resin;
and by using a differential scanning calorimeter in a nitrogen environment, the polyester resin composition is cooled from a molten state to 20° C. at a cooling rate of 20° C./min and then heated at a heating-up rate of 20° C./min, wherein an endothermic peak during the heat-up occurs at the temperature of higher than 210° C. but lower than 221° C.

20. The polyester resin composition according to claim 19, wherein the amorphous resin (B) is at least one selected from the group consisting of polycarbonate, amorphous polyester containing a cyclohexane dimethylene terephthalate unit and a styrene/acrylonitrile copolymer.

21. The polyester resin composition according to claim 19, wherein the epoxy resin (C) has a glycidyl ether structure or a glycidyl ester structure.

22. The polyester resin composition according to claim 21, wherein the epoxy resin (C) is a novolac epoxy resin containing the glycidyl ether structure represented by general formula (1): 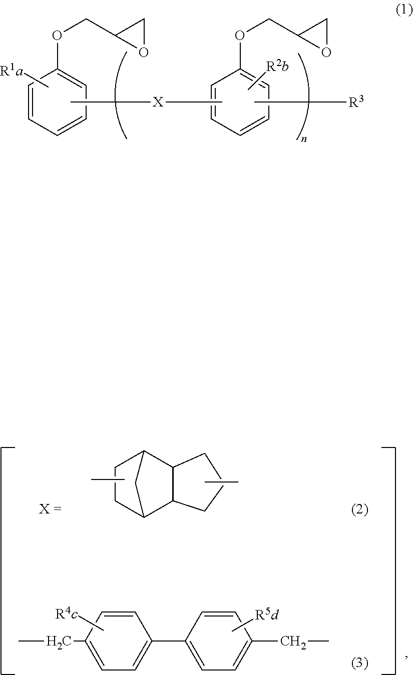
in general formula (1), X indicates a divalent group represented by general formula (2) or general formula (3); in general formulae (1) and (3), R¹, R², R⁴ and R⁵ are the same or different and each independently represent any one of an alkyl group having 1 to 8 carbon atoms, an aryl group having 6 to 10 carbon atoms or an alkyl ether group having 1 to 8 carbon atoms, and R³ indicates any one of a hydrogen atom, an alkyl group having 1 to 8 carbon atoms or an aryl group having 6 to 10 carbon atoms; in general formula (1), n indicates a value greater than 0 but less than or equal to 10; and in general formulae (1) and (3), a, c and d each independently represent integers of 0 to 4, and b is an integer of 0 to 3.

23. The polyester resin composition according to claim 19, wherein the content of the epoxy resin (C) is 0.05 to 3 parts by mass with respect to 100 parts by mass of the polybutylene terephthalate resin (A).

24. The polyester resin composition according to claim 19, wherein the polyester resin composition further comprises a filler material (D).

25. The polyester resin composition according to claim 24, wherein the filler material (D) is at least one of glass fibers or carbon fibers.

26. The polyester resin composition according to claim 24, wherein the content of the filler material (D) is one to 150 parts by mass with respect to 100 parts by mass of the polybutylene terephthalate resin (A).

27. The polyester resin composition according to claim 19, wherein the polyester resin composition further comprises a transesterification inhibitor (E).

28. The polyester resin composition according to claim 27, wherein the transesterification inhibitor (E) is a compound represented by general formula (4): 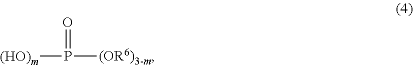
wherein R⁶ indicates an alkyl group having one to 30 carbon atoms, and m is 1 or 2.

29. The polyester resin composition according to claim 27, wherein the content of the transesterification inhibitor (E) is 0.025-0.5 parts by mass with respect to 100 parts by mass of the polybutylene terephthalate resin (A).

30. The polyester resin composition of claim 19, wherein the polyester resin composition further comprises a nucleating agent (F).

31. The polyester resin composition according to claim 30, wherein the nucleating agent (F) is at least one selected from the group consisting of silica, alumina, zirconia, titania, wollastonite, kaolin, talcum powder, mica, silicon carbide, ethylene bislauramide and a sorbitol derivative.

32. The polyester resin composition according to claim 30, wherein the content of the nucleating agent (F) is 0.05 to 5 parts by mass with respect to 100 parts by mass of the polybutylene terephthalate resin (A).

33. The polyester resin composition according to claim 19, wherein the polyester resin composition is molded under conditions of a molding temperature of 260° C. and a mold temperature of 80° C. to prepare a molded sheet with a thickness of 1 mm, which has the transmittance of more than 48% as measured with a spectrophotometer under the condition of a wavelength of 940 nm.

34. A molded product made of the polyester resin composition according to claim 19.

35. The molded product according to claim 34, wherein the molded product is a transmittable material for laser welding.

36. The molded product according to claim 34, wherein a laser-transmitting portion of the molded product has a thickness of 3 mm or less.
